(19) United States
(12) Patent Application Publication
(10) Pub. No.: US 2026/0010748 A1
(43) Pub. Date: Jan. 8, 2026

(54) IMAGE FORMING APPARATUS, RECORDING MEDIUM, AND CONTROL METHOD FOR IMAGE FORMING APPARATUS

(71) Applicant: SHARP KABUSHIKI KAISHA, Osaka (JP)

(72) Inventor: TSUTOMU ITAI, Osaka (JP)

(21) Appl. No.: 19/256,601

(22) Filed: Jul. 1, 2025

(30) Foreign Application Priority Data
Jul. 4, 2024 (JP) 2024-108140

(51) Int. Cl. G06K 15/00; G06F 3/12

(52) U.S. Cl. CPC G06K 15/4065; G06F 3/1205; G06F 3/1255; G06F 3/1257; G06F 3/1258; G06K 15/005; G06K 15/404

(57) ABSTRACT

An image forming apparatus includes: a plurality of trays in which paper attributes of paper to be accommodated are each determined; one or more controllers; and one or more storages, wherein the controllers are capable of executing a paper selection function of selecting any one of the plurality of trays and a specific function executed using any one of the plurality of trays, based on the paper attributes and job information, the one or more storages store the tray used in a job including the specific function as the job information, and the controllers release execution of the paper selection function and set the tray stored in the one or more storages as a tray to be used when the specific function is executed when execution of the specific function is required in a state in which execution of the paper selection function is set.

### CROSS-REFERENCE TO RELATED APPLICATION

The present application claims priority from Japanese Application JP2024-108140, the content to which is hereby incorporated by reference into this application.

### BACKGROUND OF THE INVENTION

### 1. Field of the Invention

The present disclosure relates to an image forming apparatus, and the like.

### 2. Description of the Related Art

Some image forming apparatus have a stapleless stapling function. The stapleless stapling function is a function for binding a plurality of sheets of paper together, and in particular, a function for binding sheets of paper without using metal staples. Further, some image forming apparatus have an automatic paper selection function. The automatic paper selection function is a function for automatically selecting a type and size of a sheet of paper. In the related art, image forming apparatus having both the stapleless stapling function and the automatic paper selection function are known.

### SUMMARY OF THE INVENTION

Generally, a stapleless stapling function has limitations on, for example, a type, size, and thickness of paper that can be applied. For example, the stapleless stapling function cannot normally be applied to thick paper. For this reason, in this type of image forming apparatus, when the automatic paper selection function is enabled and execution of the stapleless stapling function is designated, the automatic paper selection function may work and automatically change the paper to paper to which the stapleless stapling function can be applied. As a result, paper that is not intended by a user may be selected.

An object of the present disclosure is to provide an image forming apparatus and the like capable of preventing paper that is not intended by the user from being selected when executing a specific function such as a stapleless stapling function.

The present disclosure provides an image forming apparatus including: a plurality of trays in which paper attributes of paper to be accommodated are each determined; one or more controllers; and one or more storages, in which the one or more controllers are capable of executing a paper selection function of selecting any one of the plurality of trays and a specific function executed using any one of the plurality of trays, based on the paper attributes and job information, the one or more storages store the tray used in a job including the specific function as the job information, and the one or more controllers release execution of the paper selection function and set the tray stored in the one or more storages as a tray to be used when the specific function is executed, when execution of the specific function is required in a state in which execution of the paper selection function is set.

The present disclosure also provides a non-transitory computer-readable recording medium having a driver program recorded thereon, the driver program causing a computer to execute the steps of: displaying an input screen for receiving input of a print setting related to a print job; receiving a print setting related to either a paper selection function of selecting one of a plurality of trays included in an image forming apparatus or a specific function executed using one of the plurality of trays, based on paper attributes of paper to be accommodated in the plurality of trays, which is set in association with each of the plurality of trays, and job information via the input screen; and not receiving the input when a request to set execution of the paper selection function is input in a state in which execution of the specific function is set.

The present disclosure further provides a control method for an image forming apparatus including a plurality of trays having each defined paper attributes of paper to be accommodated, and capable of executing a paper selection function of selecting one of the plurality of trays and a specific function executed using one of the plurality of trays, based on the paper attributes and job information, the control method including: storing the tray used in a job including the specific function as the job information; and releasing execution of the paper selection function and setting the tray stored in the one or more storages as a tray to be used when the specific function is executed when execution of the specific function is required in a state in which execution of the paper selection function is set.

According to the present disclosure, it is possible to provide an image forming apparatus and the like capable of preventing paper not intended by a user from being selected when a specific function such as a stapleless stapling function is executed.

### BRIEF DESCRIPTION OF THE DRAWINGS

FIG. 1 is an external perspective view of an image forming apparatus according to a first embodiment of the present disclosure.

FIG. 2 is a functional block diagram of the image forming apparatus according to the first embodiment of the present disclosure.

FIG. 3 is a diagram illustrating system setting information stored in a storage of the image forming apparatus according to the first embodiment of the present disclosure.

FIG. 4 is a diagram illustrating paper feed tray information stored in a storage of the image forming apparatus according to the first embodiment of the present disclosure.

FIG. 5 is a diagram illustrating job information stored in the storage of the image forming apparatus according to the first embodiment of the present disclosure.

FIG. 6 is a diagram illustrating job history information stored in the storage of the image forming apparatus according to the first embodiment of the present disclosure.

FIG. 7 is a diagram illustrating finisher information stored in the storage of the image forming apparatus according to the first embodiment of the present disclosure.

FIG. 8 is a flowchart illustrating an operation of the image forming apparatus according to the first embodiment of the present disclosure.

FIG. 9 illustrates an example of a confirmation dialogue displayed in the image forming apparatus according to the first embodiment of the present disclosure.

FIG. 10 illustrates an example of a paper selection screen displayed in the image forming apparatus according to the first embodiment of the present disclosure.

FIG. 11 illustrates an example of a warning dialogue displayed in the image forming apparatus according to the first embodiment of the present disclosure.

FIG. 12 is a flowchart illustrating an operation of an image forming apparatus according to a second embodiment of the present disclosure.

FIG. 13A illustrates an example of a screen displayed in an image forming apparatus according to the second embodiment of the present disclosure.

FIG. 13B illustrates an example of a screen displayed in an image forming apparatus of the related art illustrated for a comparison.

FIG. 14 is a flowchart illustrating an operation of an image forming apparatus according to a variation of the second embodiment of the present disclosure.

FIG. 15 is a conceptual schematic diagram of an image forming system according to a third embodiment of the present disclosure.

FIG. 16 is a functional block diagram of the information processing apparatus according to the third embodiment of the present disclosure.

FIG. 17 is a flowchart illustrating an operation of an information processing apparatus in which a driver for the image forming apparatus is installed in an image forming system according to the third embodiment of the present disclosure.

### DETAILED DESCRIPTION OF THE INVENTION

### 1. First Embodiment

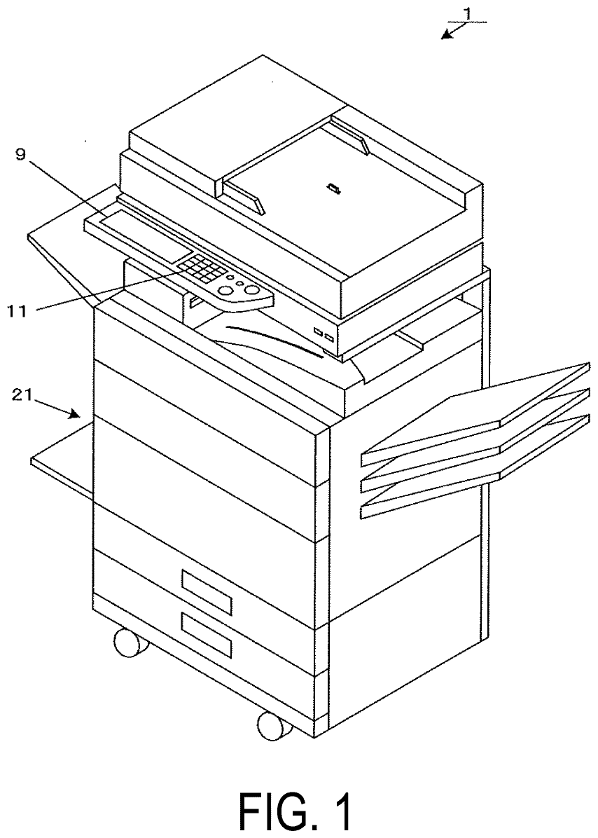

FIG. 1 is a diagram illustrating an example of an exterior of an image forming apparatus 1.

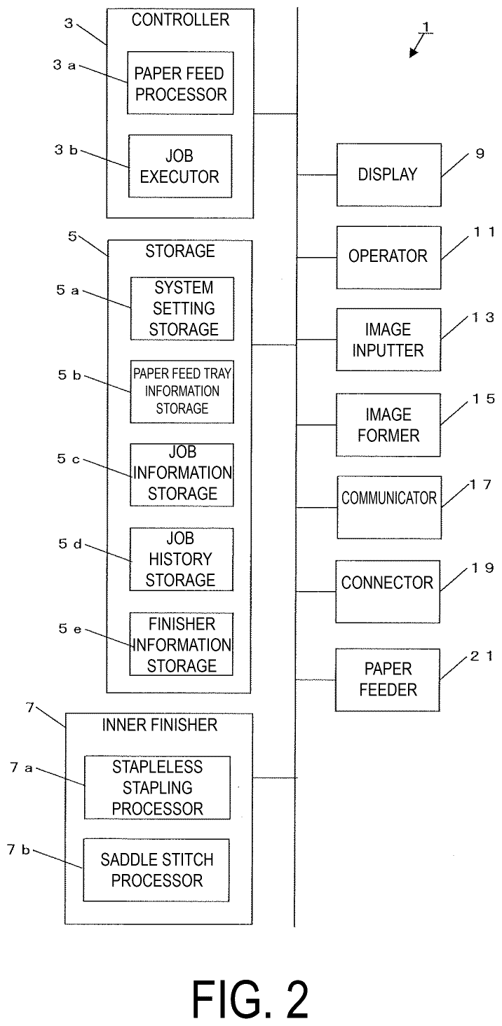

FIG. 2 is a functional block diagram of the image forming apparatus 1. The image forming apparatus 1 is a multi-function printer/peripheral (MFP) or a multifunction device, and typically has a copy function, an image scanner function, a facsimile function, and a printer function. The image forming apparatus may further have other functions, such as an email sending and receiving function, a file server function, and the like. The image forming apparatus 1 includes a controller 3, a storage 5, an inner finisher 7, a display 9, an operator 11, an image inputter 13, an image former 15, a communicator 17, a connector 19, and a paper feeder 21.

The controller 3 controls the entire image forming apparatus. The controller 3 includes one or more control devices or control circuits, and includes, for example, a central processing unit (CPU), which is a processor that executes various arithmetic processes, a system on a chip (SoC), and the like.

Further, the controller 3 can realize each function by reading the programs stored in the storage 5 and executing the process. In particular, the controller 3 operates as a paper feed processor 3a and a job executer 3b. The paper feed processor 3a mainly controls the paper feeder 21 to execute the process for supplying paper to the image former 15. The paper feed processor 3a can execute the automatic paper selection function. The automatic paper selection function is executed when the automatic paper selection function stored in the system setting storage 5a is ON. The automatic paper selection function selects one of a plurality of paper feed trays of the paper feeder 21, based on paper feed tray information stored in the paper feed tray information storage 5b and the job information stored in the job information storage 5c. The job executer 3b mainly controls the image former 15 to execute processing for forming an image on the paper supplied from the paper feeder 21. The automatic paper selection function is also a type of restriction function. When a specific function is a stapleless stapling function, the restriction functions may include a saddle stitch function, a poster printing function, and a photo printing function in addition to the automatic paper selection function.

The storage 5 stores various programs and various pieces of data necessary for an operation of the image forming apparatus.

The storage 5 includes one or more recording devices capable of temporary storage, such as a dynamic random access memory (DRAM) or one or more non-temporary recording devices, such as a solid state drive (SSD) made of semiconductor memory or a hard disk drive (HDD) made of a magnetic disk. Further, for convenience of explanation, the storage 5 is configured as one unit, but the storage 5 may be configured as separate devices for each purpose, such as an area used for execution of programs (main storage area), an area that stores programs or data (auxiliary storage area), and an area used for caching.

The storage 5 includes the system setting storage 5a, the paper feed tray information storage 5b, the job information storage 5c, a job history storage 5d, and a finisher information storage 5e. Each of these storages will be described below.

The inner finisher 7 is a finisher built into the image forming apparatus 1. The inner finisher 7 includes a stapleless stapling processor 7a and a saddle stitch processor 7b. The stapleless stapling processor 7a staples corners of stacked sheets of paper together using stapleless stapling. The saddle stitch processor 7b folds the stacked sheets of paper in half at a center and staples the sheets together using a staple (metal staple). The stapleless stapling function is executed by the controller 3 using the stapleless stapling processor 7a. The stapleless stapling function is also called a specific function.

The display 9 displays images and text. For example, the display 9 is configured of a liquid crystal display (LCD) or an organic Electro-Luminescence (EL) panel. The display 9 may be a standalone display device, or may further include an externally connected display device.

The operator 11 receives operation input from the user. For example, the operator 11 is configured of hardware keys and/or software keys. Further, the operator 11 includes operation keys such as task keys for instructing the execution of tasks such as FAX transmission or image reading, and a stop key for instructing stop of an operation.

The image inputter 13 reads an image (manuscript) and outputs image data. The image inputter 13 is configured of a typical scanner (image input device). Further, the image inputter 13 may input image data from an external storage medium such as a USB flash drive, or may receive image data via a network.

The image former 15 forms (prints) an image on a medium such as copy paper, based on the image data. A printing scheme for the image former 15 is freely selected, and may be, for example, any of an inkjet printer, a laser printer, a thermal transfer printer, and the like. The image former 15 is capable of both black and white printing and color printing. The image former 15 may include a paper feed mechanism that supplies the medium, a transport mechanism that transports the medium, a sorter mechanism that sorts the medium after an image is formed, and the like.

The communicator 17 connects to a network. For example, the communicator 17 is configured of an interface that can be connected to a wired local area network (LAN), a wireless LAN, or a long term evolution (LTE) network. The communicator 17 is connected to a network for connection to another device or an external network. In addition, the communicator 17 may be an interface for short-distance wireless communication such as near field communication (NFC) or Bluetooth (trade name).

The connector 19 connects the image forming apparatus to another device. For example, the connector 19 is a USB interface to which a USB flash drive or the like is connected. Further, the connector 19 may be an interface such as HDMI (trade name), in addition to the USB interface.

The paper feeder 21 includes five paper feed trays, one manual feed tray, and a transport mechanism for transporting the paper accommodated in the trays to the image former 15, but the number of paper feed trays is not limited thereto.

The five paper feed trays accommodate paper of the same type and size. Each paper feed tray has a tray number. The plurality of paper feed trays may store paper of the same type and size. All the paper feed trays may accommodate paper of different types and sizes.

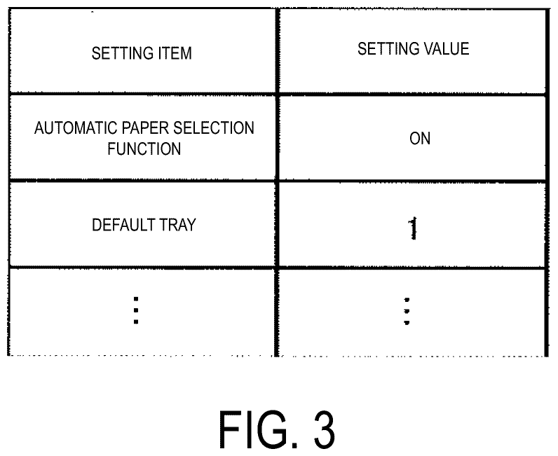

FIG. 3 is a diagram illustrating system setting information stored in the system setting storage 5a of the storage 5 of the image forming apparatus 1 according to the first embodiment of the present disclosure. The system setting information is an area for storing various setting pieces of information of the image forming apparatus 1 set by, for example, an administrator of the image forming apparatus 1 via the display 9 and the operator 11. In particular, the system setting information includes an ON/OFF setting of the automatic paper selection function and a setting of a default tray. The automatic paper selection function is a function of selecting a tray that accommodates paper, based on a job setting or paper attributes (paper size, paper type, and the like) to be described below. The default tray is a tray that is selected when the automatic paper selection function is OFF and the user has not performed an operation to select paper (tray) via the operator 11. In the example of FIG. 3, the automatic paper selection function is set to ON, and tray 1 is selected as the default tray. The system setting information includes the destinations of the image forming apparatus 1 and the inner finisher 7.

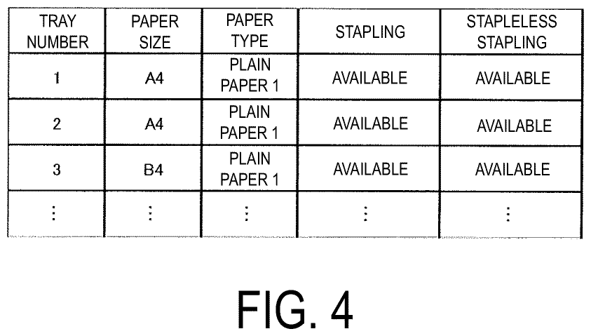

FIG. 4 is a diagram illustrating the paper feed tray information stored in the paper feed tray information storage 5b of the storage 5 of the image forming apparatus 1 according to the first embodiment of the present disclosure. The paper feed tray information includes a tray number, paper size, paper type, compatibility with stapling, and compatibility with stapleless stapling. In FIG. 4, for example, the paper feed tray with tray number 1 accommodates A4-size plain paper 1, and indicates that both stapling and stapleless stapling are possible. The plain paper 1 is a type of paper.

The paper feed tray information storage 5b stores values set by, for example, the administrator of the image forming apparatus 1 via the display 9 and the operator 11. As for a value of the paper size, a sensor for acquiring the paper size may be provided in the paper feed tray, and the controller 3 may store a value acquired using the sensor.

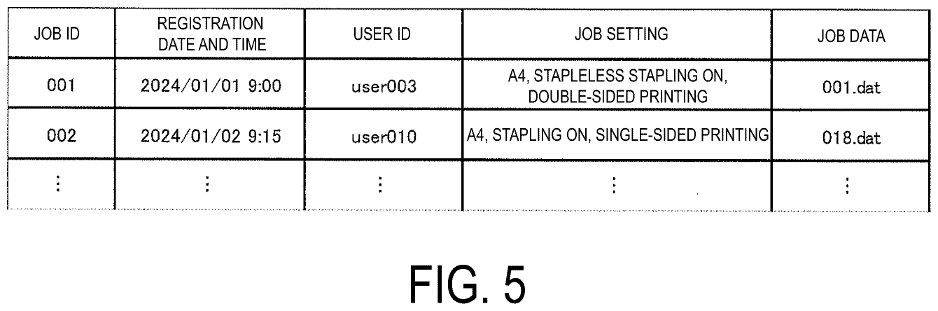

FIG. 5 is a diagram illustrating the job information stored in the job information storage 5c of the storage 5 of the image forming apparatus 1 according to the first embodiment of the present disclosure. The job information includes a job ID, a registration date and time, a user ID, a job setting, and job data. The job ID is identification information for uniquely identifying a job. The registration date and time is a date and time when the job has been registered. The user ID is user identification information for uniquely identifying a user who uses the image forming apparatus 1 when the job has been registered (a user who has registered the job in the image forming apparatus 1). The job setting is a setting related to the job. The job data is data of the job. For example, the job information in FIG. 5 indicates that the job with job ID 001 is to perform double-sided printing by turning on the stapleless stapling using A4 size paper under a user ID such as user003 at 9:00 a.m. on Jan. 1, 2024, and the job data is “001.dat”.

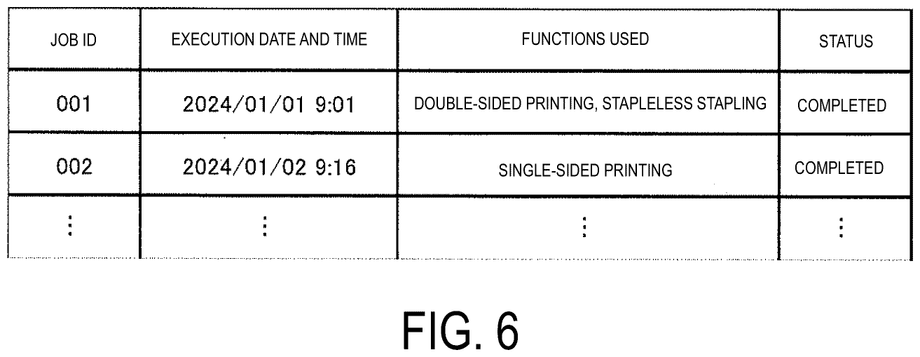

FIG. 6 is a diagram illustrating job history information stored in the job history storage 5d of the storage 5 of the image forming apparatus 1 according to the first embodiment of the present disclosure. The job history information includes a job ID, an execution date and time, a used function, and a status. The execution date and time is a date and time when the image forming apparatus 1 (controller 3) has executed the job. The used function is a function used when the job has been executed. The status is a current state of the job. The job history information in FIG. 6 indicates, for example, that the job with job ID of 001 has been executed at 9:01 a.m. on Jan. 1, 2024, that a double-sided printing function and a stapleless stapling function have been executed at that time, and that the execution of the job has been completed.

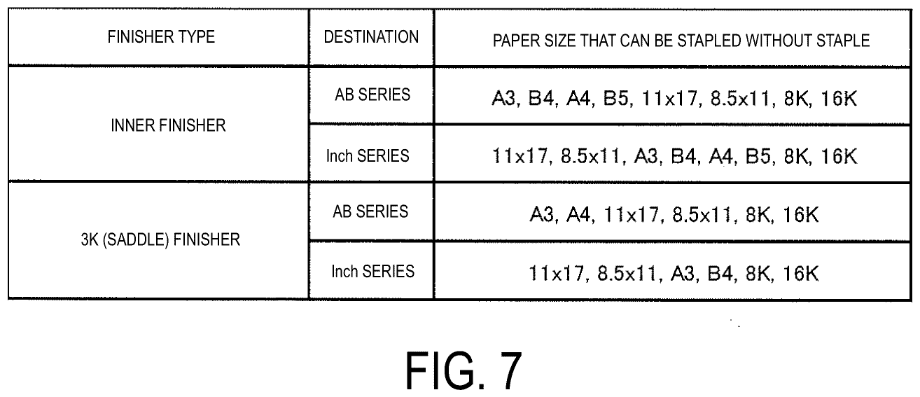

FIG. 7 is a diagram illustrating the finisher information stored in the finisher information storage 5e of the storage 5 of the image forming apparatus 1 according to the first embodiment of the present disclosure. The finisher information indicates, for each type of finisher and destination of the finisher, the size of the paper that can be stapled without staples, and an order in which these paper sizes are described. An AB series is a paper size standard established by the Japanese Industrial Standards based on millimeters, and has an A size and a B size. An inch series is an Anglo-American standard established based on inches. The destination being the AB series indicates that the destination of the finisher is an area in which the AB series paper is mainly used, and the destination being the inch series indicates that the destination of the finisher is an area in which inch series paper is mainly used.

In the finisher information of FIG. 7, when the destination of the inner finisher is the AB series, the paper sizes are displayed in order of A3, B4, A4, B5, 11×17, 8.5×11, 8K, and 16K. On the other hand, when the destination of the inner finisher is an inch series, the paper sizes are displayed in order of 11×17, 8.5×11, A3, B4, A4, B5, 8K, and 16K.

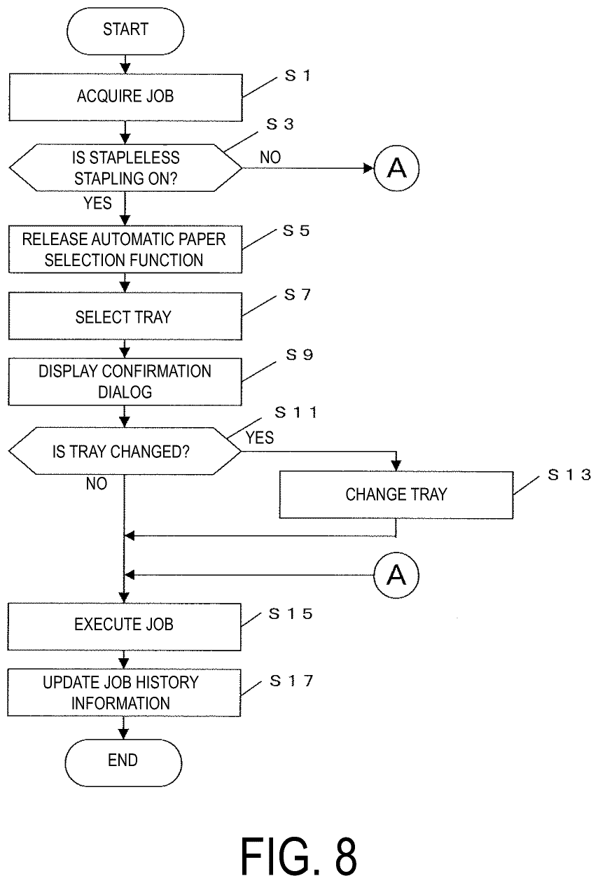

FIG. 8 is a flowchart illustrating an operation of the image forming apparatus 1 according to the first embodiment of the present disclosure. Now, it is assumed that the automatic paper selection function is set to ON in the system setting storage 5a, and the paper feed processor 3a is executing the automatic paper selection function. The controller 3 acquires a job to be executed (step S1). The controller 3 may acquire a job set by the user of the image forming apparatus 1 via the display 9 and the operator 11, or may acquire a job from an external device connected via the communicator 17 or the connector 19. Next, the controller 3 determines whether the stapleless stapling function is turned on (execution of the stapleless stapling function is requested) (step S3). When the stapleless stapling function is turned on (step S3, YES), the paper feed processor 3a stops (releases) the automatic paper selection function (step S5). Next, the paper feed processor 3a refers to the job history stored in the job history storage 5d to acquire the tray number of the paper feed tray for the job in which a use function is stapleless stapling and a status is completed, and select the tray as the paper feed tray to be used (step S7). When there is no job history, an initial value of the tray number separately stored in the storage 5 in advance is used. Next, the controller 3 displays a confirmation dialogue on the display 9 (step S9). As will be described below, information on the currently selected paper feed tray (paper feed tray to be used) and an explanation of an operation for changing the paper feed tray are displayed in the confirmation dialogue, and information on the paper that can be stapled without staples and information on paper that cannot be stapled without staples are displayed. The controller 3 displays a paper selection screen (described below) that allows the user to select a tray to which the currently selected paper feed tray is to be changed from among a plurality of trays accommodating the paper when the user selects to change the paper feed tray in the confirmation dialogue (step S11, YES), and changes the paper feed tray to be used to the paper feed tray designated as the change destination by the user when an operation related to changing the paper feed tray is received on the paper selection screen (step S13). When the user does not select to change the paper feed tray (step S11, NO), the process proceeds to the next step. Next, the job executer 3b executes the job acquired in step S1 using the paper feed tray selected in step S7 or the paper feed tray changed in step S13 (step S15). Next, the controller 3 updates the job history in the job history storage 5d in accordance with the result of executing the job (step S17). When the stapleless stapling function is OFF (step S3, NO), the controller 3 proceeds to step S15.

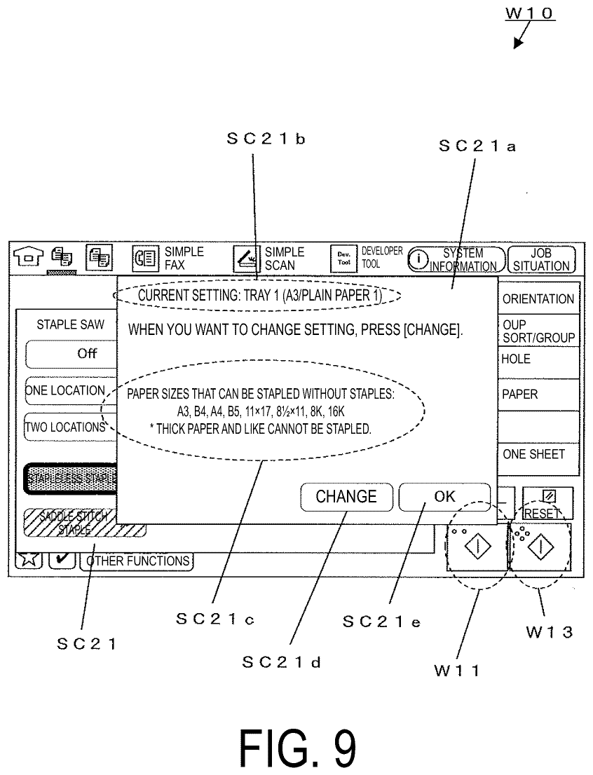

FIG. 9 is an example of a confirmation dialogue SC21a displayed on the image forming apparatus 1 according to the first embodiment of the present disclosure. When a staple sort screen SC21 is displayed on a print job screen W10 for copying, printing, or the like, and the stapleless stapling function is set to be enabled, the confirmation dialogue SC21a is displayed to be superimposed on the staple sort screen SC21. The print job screen W10 has print start buttons W11 and W13. The confirmation dialogue SC21a includes a tray display SC21b, a candidate display SC21c, change button SC21d, and an OK button SC21e. The confirmation dialogue SC21a is displayed in step S9.

The tray display SC21b displays the tray selected in step S7, the size of the paper accommodated in the tray, and the type of the paper. The candidate display SC21c displays candidate papers that can be changed from the paper displayed in the tray display SC21b. The controller 3 acquires the size of the paper that can be stapled without staples which corresponds to a destination of the inner finisher 7 stored in the system setting storage 5a in the finisher information stored in the finisher information storage 5e, and displays the paper size in the candidate display SC21c. In this case, a display order of the paper sizes is a display order of the paper sizes in the finisher information. The candidate display SC21c in FIG. 9 is an example when the destination of the inner finisher 7 is stored as the AB series in the system setting storage 5a. When the change button SC21d is operated via the operator 11, the controller 3 proceeds to step S13 and displays a paper selection screen SC23 (to be described below) on the display 9. When the OK button SC21e is operated via the operator 11, the controller 3 ends the display of the confirmation dialogue SC21a, and then when an instruction to confirm a stapleless stapling setting (for example, an instruction to select an OK button (not shown)) is issued on the staple sort screen SC21, and an instruction to start the execution of the print job (an instruction to select the print start button) is issued on the print job screen W10, the process proceeds to step S15. The print start button W11 is a button for instructing the controller 3 to start monochrome printing using the image former 15 in response to an operation via the operator 11. The print start button W13 is a button for instructing the controller 3 to start color printing using the image former 15 in response to an operation via the operator 11. The number of print start buttons is not limited to two, and there may be one button.

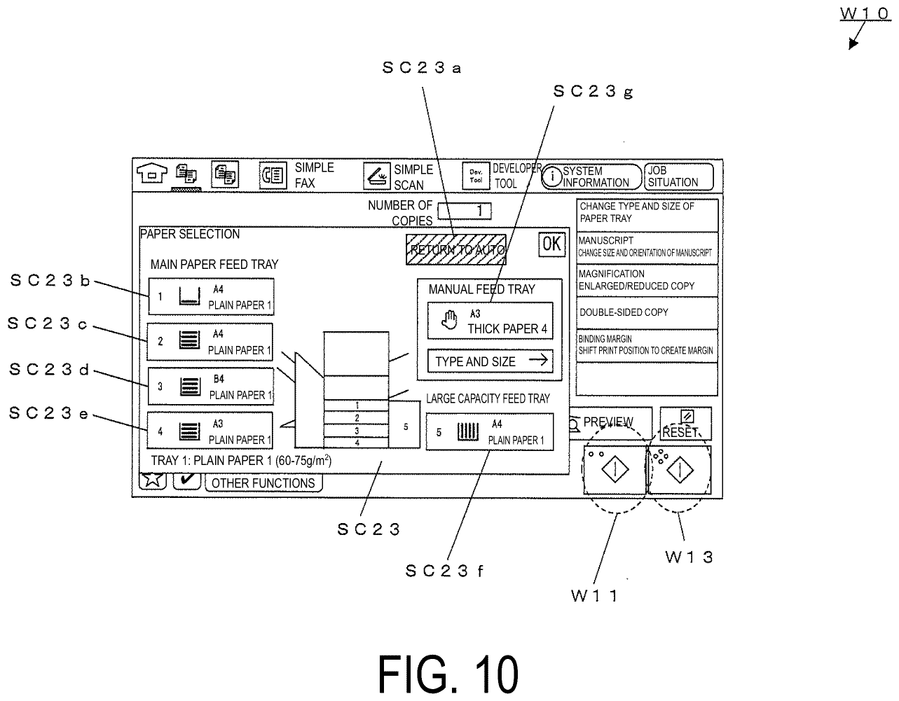

FIG. 10 illustrates an example of a paper selection screen displayed on the image forming apparatus 1 according to the first embodiment of the present disclosure. The paper selection screen SC23 is displayed in step S13. The paper selection screen SC23 includes a return to auto button SC23a, tray selection buttons SC23b to SC23g, and print start buttons W11 and W13.

The return to auto button SC23a is a button for resuming the automatic paper selection function released in step S5, but is displayed in a grayed-out state indicating that no operation is received on the paper selection screen SC23. The return to auto button SC23a is displayed in a grayed-out state in order to maintain the release of the automatic paper selection function in step S5.

The tray selection buttons SC23b to SC23g correspond, in order, to paper feed trays 1 to 5 and the manual feed tray. When any of the tray selection buttons SC23b to SC23g is operated via the operator 11, the controller 3 changes the paper feed tray to be used from the tray selected in step S7 to the tray corresponding to the operated tray selection button.

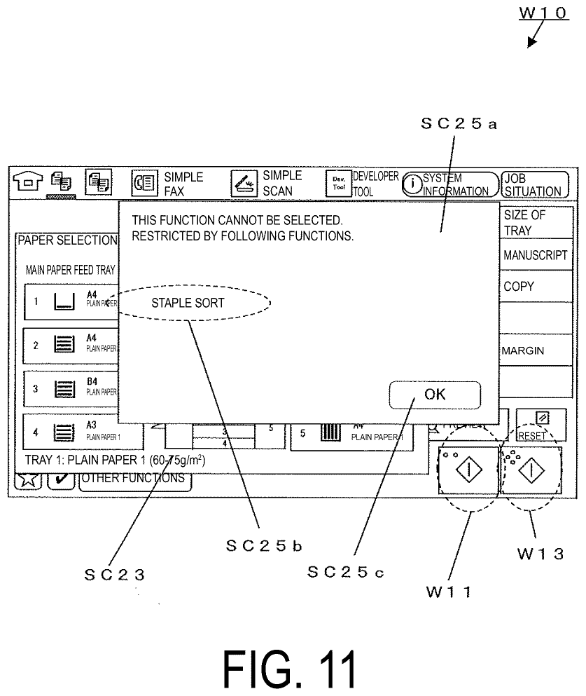

FIG. 11 is an example of a warning dialogue displayed on the image forming apparatus 1 according to the first embodiment of the present disclosure. A warning dialogue SC25a is displayed to be superimposed on the paper selection screen SC23. The warning dialogue SC25a includes a function display SC25b and an OK button SC25c. The warning dialogue SC25a is displayed in response to an operation of the return to auto button SC23a on the paper selection screen SC23 in FIG. 10. The function display SC25b is a display related to a function that causes the automatic paper selection function to be restricted. When the OK button SC25c is operated via the operator 11, the controller 3 ends the display of the warning dialogue SC25a.

The print job screen W10 in FIGS. 10 and 11 has two print start buttons W11 and W13 at a lower right corner of the screen, but instead of these, a message (for example, “Please select paper”) for prompting the user to select paper may be displayed at a lower right corner of the print job screen W10.

As described above, according to the first embodiment, when the stapleless stapling function is ON (enabled), the automatic paper selection function is released, the same paper feed tray as that used in the job previously completed with stapleless stapling turned on is selected, and the selected tray is displayed as the currently selected tray in the confirmation dialogue for the user. Further, when the user wishes to change to paper accommodated in another paper feed tray, the user can select the size of the paper that can be stapled without staples by the size of the paper that can be stapled without staples being presented to the user. This makes it possible to select the paper that can be stapled without staples with user's confirmation when the stapleless stapling function is ON, and prevent the user from selecting paper that is not intended.

### 2. Second Embodiment

A second embodiment of the present disclosure will be described. In the second embodiment, when paper that is not compatible with the stapleless stapling function is selected on the paper selection screen SC23 of the first embodiment, the stapleless stapling function is released to enable execution of the job. Only parts of a configuration and processing different from the first embodiment will be mainly described.

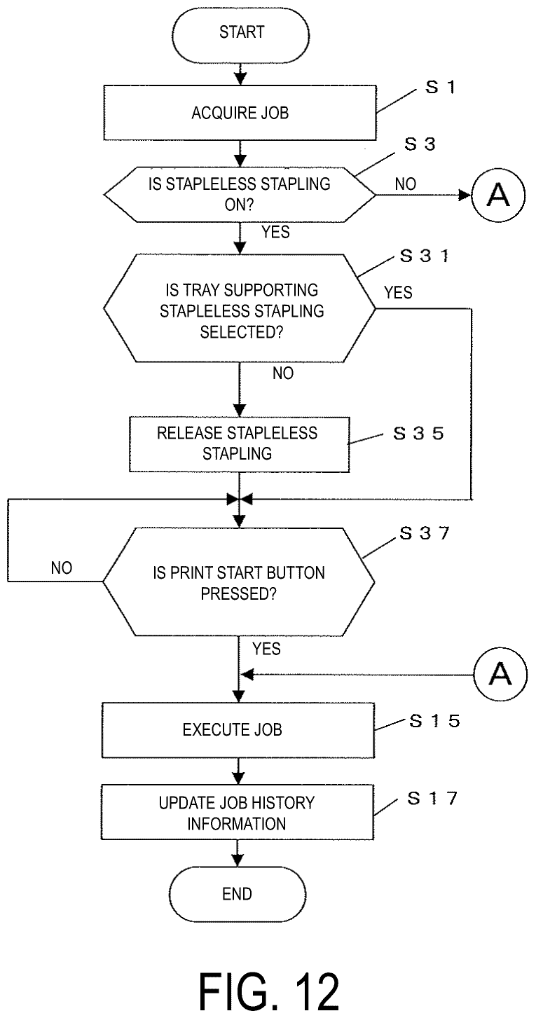

FIG. 12 is a flowchart illustrating an operation of the image forming apparatus 1 according to the second embodiment of the present disclosure. Steps S1 and S3 are the same as those of the first embodiment. When the stapleless stapling function is ON (step S3, YES), the controller 3 determines whether the paper accommodated in the currently selected tray is paper that can be stapled without staples, based on the paper feed tray information in the paper feed tray information storage 5b (step S31). When it is determined that the paper is the paper that can be stapled without staples (step S31, YES), the controller 3 proceeds to step S37. When it is determined that the paper is not the paper that can be stapled without staples (step S31, NO), the paper feed processor 3a stops (releases) the stapleless stapling and displays the print start buttons W11 and W13 in an operable state on the print job screen W10 (step S35). Next, the controller 3 determines whether the print start button W11 or W13 has been operated via the operator 11 (step S37). When the print start button W11 has been operated via the operator 11 (step S37, YES), the controller 3 starts the monochrome printing using the image former 15 (step S15). Alternatively, when the print start button W13 has been operated via the operator 11 (step S37, YES), the controller 3 starts the color printing using the image former 15 (step S15). Next, the controller 3 updates the job history in the job history storage 5d in accordance with the result of executing the job (step S17). While the print start button W11 is not operated via the operator 11 (step S37, NO), the controller 3 waits.

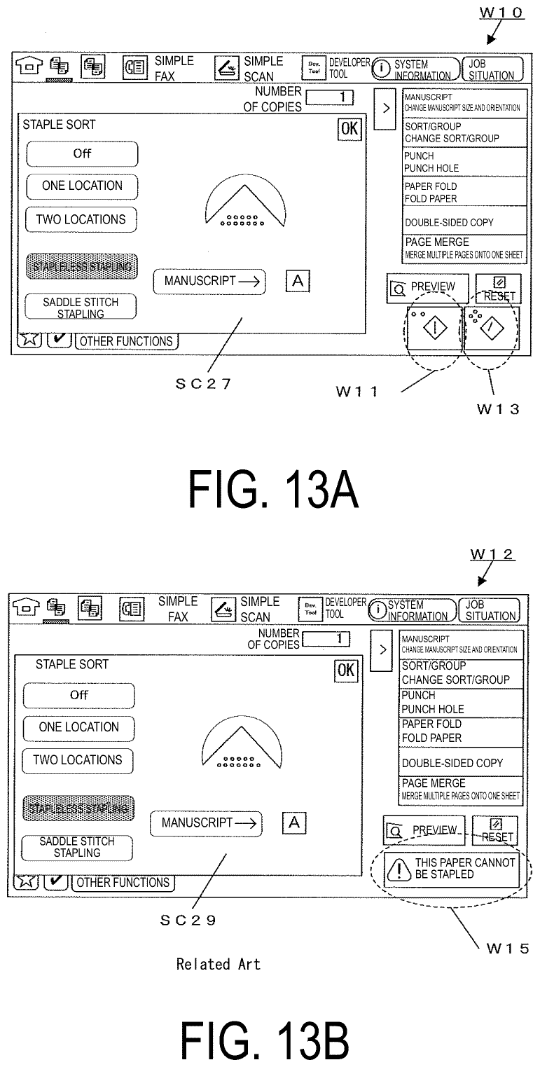

FIG. 13A is an example of a screen displayed on the image forming apparatus 1 according to the second embodiment of the present disclosure (an example of a screen displayed in step S35). In FIG. 13A, a staple sort screen SC27 is displayed to be superimposed on the print job screen W10. In the second embodiment of the present disclosure, even when the stapleless stapling function is set to ON and the paper accommodated in the currently selected tray is not the paper that can be stapled without staples, the print start buttons W11 and W13 are displayed in an operable state on the print job screen W10, and therefore, a print job can be executed without stapleless stapling (a state in which the stapleless stapling function is released).

FIG. 13B is an example of a screen displayed on the image forming apparatus of the related art, which is illustrated for comparison. In FIG. 13B, a staple sort screen SC29 is displayed to be superimposed on the print job screen W12. In the print job screen W12, a warning message W15 is displayed at a position where the print start buttons W11 and W13 are displayed on the print job screen W10. The warning message W15 states a message indicating that “This paper cannot be stapled.”

The print job screen W12 is an example of a screen that is displayed when the stapleless stapling function is ON and paper that cannot be stapled without staples is selected in the image forming apparatus of the related art. In an operation of the second embodiment described above, when the stapleless stapling function is ON, printing is possible regardless of whether the paper to be printed on can be stapled without staples, whereas in the image forming apparatus of the related art, when the paper to be printed on cannot be stapled without staples, the warning message W15 is displayed and printing is not possible. Thus, according to the second embodiment, when the stapleless stapling function is ON, printing can be performed on the selected paper regardless of whether the paper selected by the user on the paper selection screen can be stapled without staples (even when the paper cannot be stapled without staples).

### 2.1 Variation of Second Embodiment

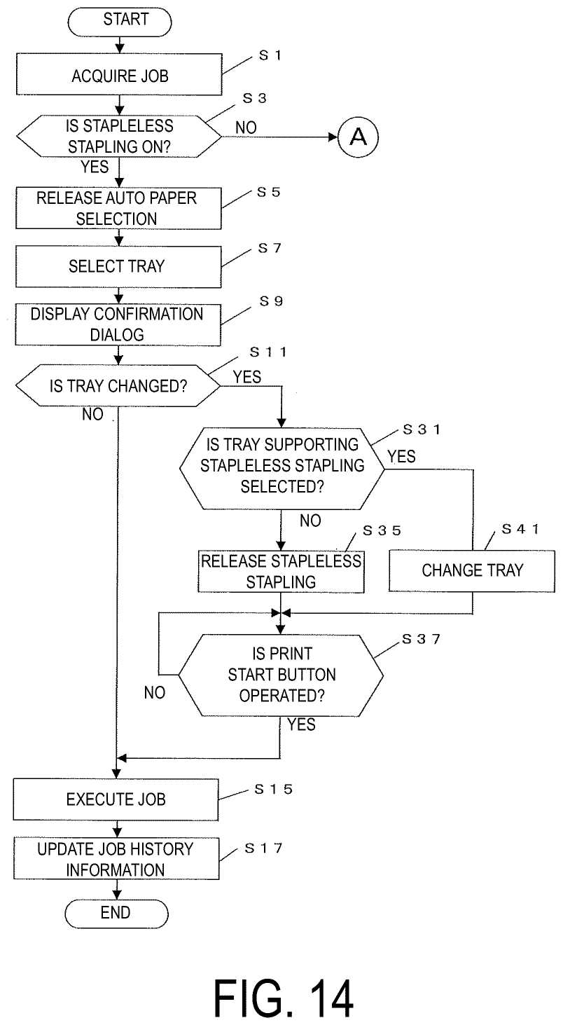

FIG. 14 is a flowchart illustrating an operation of an image forming apparatus according to a variation of the second embodiment of the present disclosure. Steps S1 to S11 are the same as in the first embodiment. When the user does not select to change the paper feed tray in step S11 (step S11, NO), the job executer 3b executes the job acquired in step S1 using the paper feed tray selected in step S7 (step S15).

On the other hand, when the user selects to change the paper feed tray in step S11 (step S11, YES), steps S31, S35, and S37 are executed as in the second embodiment described above. However, when it is determined in step S31 that the paper feed tray designated as the change destination by the user in step S11 is a paper feed tray accommodating the paper that can be stapled without staples, the paper feed tray to be used is changed to the paper feed tray designated as the change destination in step S11 by the user (step S41).

According to a variation of the second embodiment, when the paper in the changed tray cannot be stapled without staples, the stapleless stapling can be released.

### 3. Third Embodiment

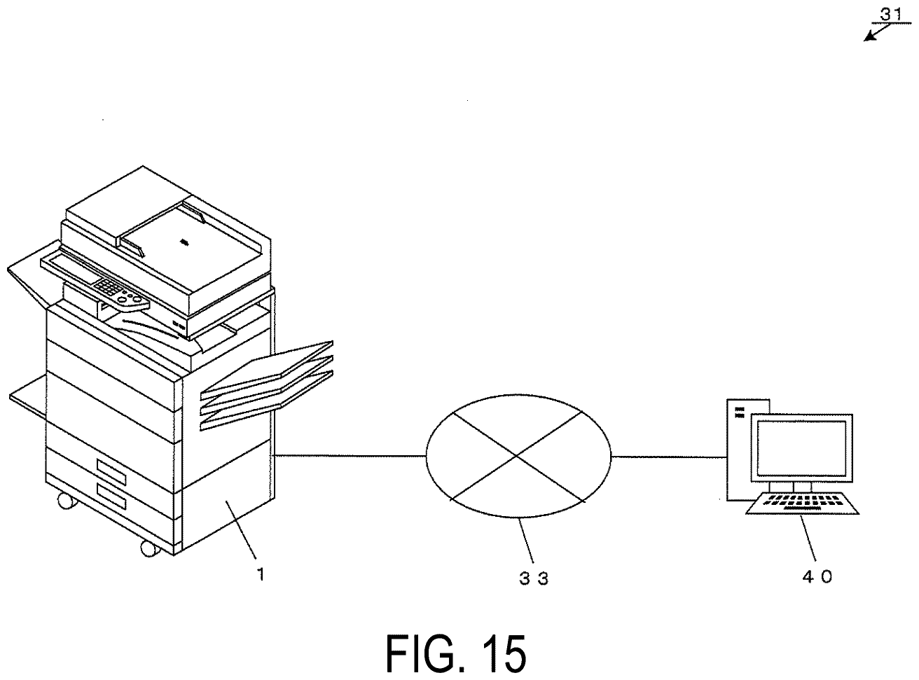

FIG. 15 is a conceptual schematic diagram of an image forming system 31 according to a third embodiment of the present disclosure. The image forming system 31 includes an image forming apparatus 1, a network 33, and an information processing apparatus 40. The image forming apparatus 1 is the same as that described in the first embodiment. However, the communicator 17 is connected to the network 33, and data communication with the information processing apparatus 40 is possible via the network 33. The network 33 is a data communication network, such as the Internet or a local area network (LAN). The information processing apparatus 40 is a personal computer such as a desktop computer or a laptop computer, or a workstation. The information processing apparatus 40 may be a computer other than a personal computer or a workstation, such as a tablet or a smartphone.

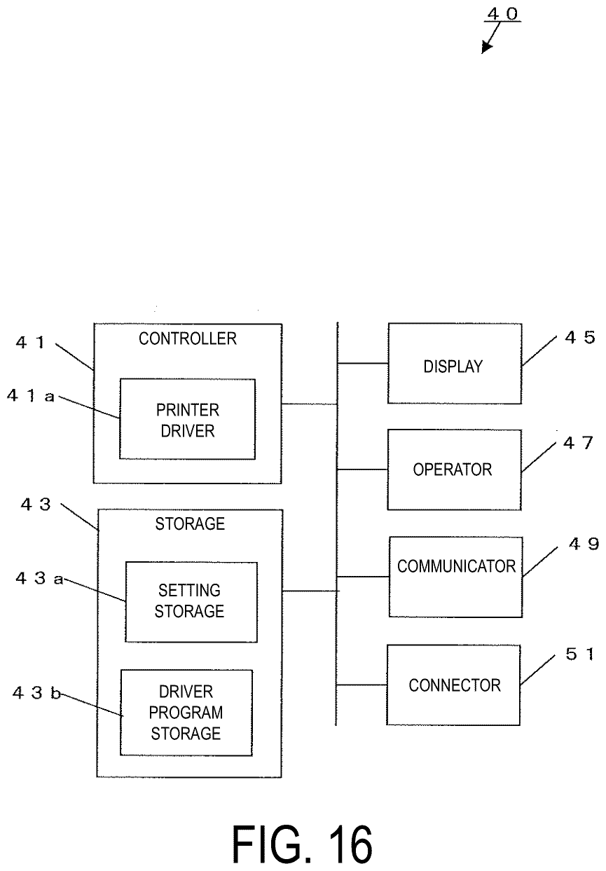

FIG. 16 is a functional block diagram of the information processing apparatus 40 according to the third embodiment of the present disclosure. The information processing apparatus 40 includes a controller 41, a storage 43, a display 45, an operator 47, a communicator 49, and a connector 51.

The controller 41 controls the entire image forming apparatus. The controller 41 includes one or more control devices or control circuits, and includes, for example, a central processing unit (CPU), which is a processor that executes various arithmetic processes, a system on a chip (SoC), and the like.

Further, the controller 41 can realize each function by reading the programs stored in the storage 43 and executing the processing. In particular, the controller 41 operates as a printer driver 41a by reading a driver program from the storage 43 (driver program storage 43b). The printer driver 41a instructs the image forming apparatus 1 to print via the communicator 49 and the network 33, based on printer setting (print settings) set by a user of the information processing apparatus 40 via the display 45 and the operator 47.

The storage 43 stores various programs or various pieces of data necessary for an operation of the image forming apparatus. The storage 43 includes one or more recording devices capable of temporary storage, such as a dynamic random access memory (DRAM) or one or more non-temporary recording devices, such as a solid state drive (SSD) made of semiconductor memory or a hard disk drive (HDD) made of a magnetic disk. Further, for convenience of explanation, the storage 43 is configured as one unit, but the storage 43 may be configured as separate devices for each purpose, such as an area used for execution of programs (main storage area), an area that stores programs or data (auxiliary storage area), and an area used for caching.

The storage 43 includes a setting storage 43a and a driver program storage 43b. When the user of the information processing apparatus 40 sets the printer setting via the display 45 and the operator 47, the printer driver 41a stores the printer setting in the setting storage 43a.

The display 45 displays images and characters. For example, the display 45 is configured of a liquid crystal display (LCD) or an organic Electro-Luminescence (EL) panel. The display 45 may be a standalone display device, or may further include an externally connected display device. In particular, the display 45 displays a screen allowing the printer driver 41a to receive printer setting.

The operator 47 receives operation input from the user. For example, the operator 47 is configured of hardware keys and/or software keys. In particular, the operator 47 is used when the printer setting is performed.

The communicator 49 connects to the network 33. For example, the communicator 49 is configured of an interface that can be connected to a wired local area network (LAN), a wireless LAN, or a long term evolution (LTE) network.

The communicator 49 is connected to a network for connection to another device or an external network. In addition, the communicator 49 may be an interface for short-distance wireless communication such as near field communication (NFC) or Bluetooth (trade name).

The connector 51 connects the information processing apparatus 40 to another device.

The other device may be the image forming apparatus 1. For example, the connector 51 is a USB interface to which a USB flash drive or the like is connected. Further, the connector 51 may be an interface such as HDMI (trade name), in addition to the USB interface.

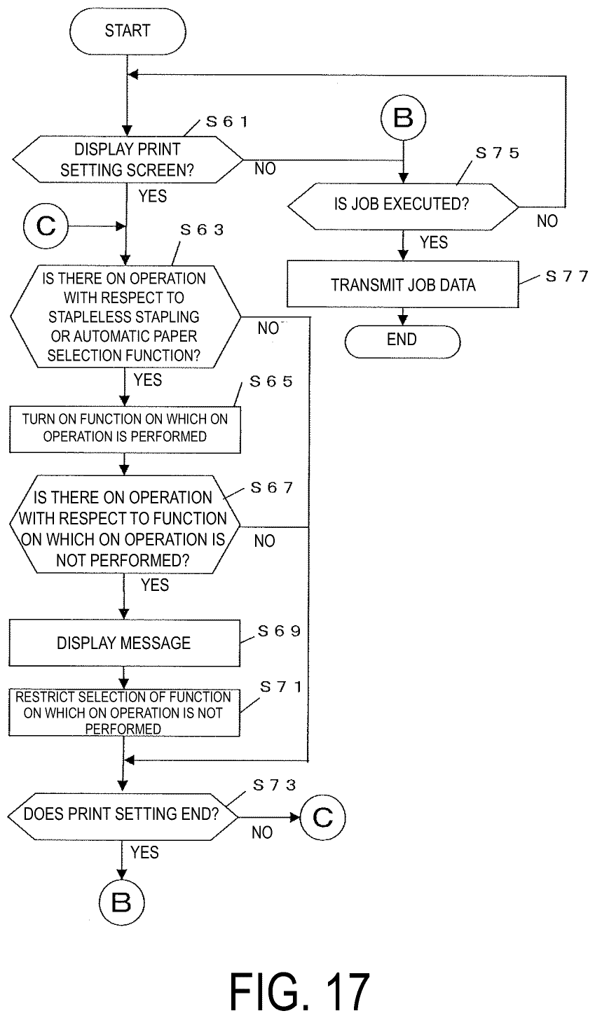

FIG. 17 is a flowchart illustrating an operation of the information processing apparatus 40 in which the printer driver 41a of the image forming apparatus 1 is installed in the image forming system 31 according to the third embodiment of the present disclosure.

The printer driver 41a determines whether an operation to display a print setting screen for making print settings has been performed (step S61). The print setting screen is also called an input screen. When the user performs an operation to display the print setting screen via the operator 47 (step S61, YES), the printer driver 41a displays, on the display 45, the print setting screen on which, for example, change of various setting values related to the print job can be received, and receives, for example, an operation to perform change related to the print setting via the operator 47.

The printer driver 41a determines whether an operation to set either the stapleless stapling function or the automatic paper selection function to ON has been received via the operator 47 (step S63). When an operation to turn on either the stapleless stapling function or the automatic paper selection function is received (step S63, YES), the printer driver 41a turns on the function that the operation to turn on has been received (step S65). When the operation to turn on the stapleless stapling function is received in step S63, the stapleless stapling function is set to ON in step S65. On the other hand, when the operation to turn on the automatic paper selection function is received in step S63, the automatic paper selection function is set to ON in step S65.

Next, the printer driver 41a determines whether an operation to turn on a function that is not turned on in step S65 between the stapleless stapling function and the automatic paper selection function (an operation to request the execution of the function that is not turned on in step S65) has been received via the operator 47 after the ON operation in step S63 (step S67). When the operation to turn on the stapleless stapling function has been received in step S63 and the stapleless stapling function has been set to ON in step S65, it is determined whether the operation to turn on the automatic paper selection function has been received. On the other hand, when the operation to turn on the automatic paper selection function has been received in step S63 and the automatic paper selection function has been set to ON in step S65, it is determined whether an operation to turn on stapleless stapling has been received.

When it is determined in step S67 that an operation to turn on a function that is not ON in step S65 between the stapleless stapling and the automatic paper selection function has been received (step S67, YES), the printer driver 41a displays a message on the display 9 (step S69). It is considered that the message may include, for example, a message indicating that the function set as an operation target in step S67 cannot be turned on due to the function turned on in step S65. Further, it is considered that the message further includes a message indicating that it is necessary to turn off the function that has been turned on in step S65 in order to turn on the function set as the operation target in step S67.

For example, when the stapleless stapling function is set to ON in step S65 and the operation to turn on the automatic paper selection function is received in step S67, the printer driver 41a displays a message including a message indicating that the automatic paper selection function cannot be turned on because the stapleless stapling function is set to ON, and/or a message indicating that it is necessary to turn off the stapleless stapling in order to turn on the automatic paper selection function. On the other hand, when the automatic paper selection function is set to ON in step S65 and the operation to turn on stapleless stapling function is received in step S67, the printer driver 41a displays a message including a message indicating that the stapleless stapling cannot be turned on because the automatic paper selection function is set to ON, and/or a message indicating that it is necessary to turn off the automatic paper selection function in order to turn on the stapleless stapling.

Next, when the display of the message displayed in step S69 is ended in response to an instruction from the user, the printer driver 41a restricts the selection of functions that is not turned on in step S65 (step S71). When the stapleless stapling function is turned on in step S65 and then the operation to turn on the automatic paper selection function is performed in step S67, the printer driver 41a restricts the turning on of the automatic paper selection function selected later. This restriction may be realized by turning on the automatic paper selection function once (selected state) in response to the operation to turn on the automatic paper selection function, and then returning the automatic paper selection function to OFF (non-selected state). Alternatively, in this restriction, when the operation to turn on the automatic paper selection function is performed, the operation may be ignored and the automatic paper selection function is left OFF. When this restriction is performed, the same message as the message displayed in step S69 may be displayed. When the determination in step S67 is “YES”, the printer driver 41a may omit step S69 and execute the process of step S71.

On the other hand, when the automatic paper selection function is turned on in step S65 and then the operation to turn on the stapleless stapling function is performed in step S67, the printer driver 41a restricts the turning on of the stapleless staple. This restriction may be realized by turning on the stapleless stapling function once (selected state) in response to the operation to turn on the stapleless staple, and then returning the stapleless stapling function to OFF (non-selected state). Alternatively, this restriction may be realized by ignoring the operation to turn on the stapleless stapling function and leaving the stapleless stapling function OFF when the operation to turn on the stapleless stapling function is performed. When this restriction is performed, the same message as the message displayed in step S69 may be displayed.

When an operation to end the setting on the print setting screen (for example, an operation with respect to an end button provided on the print setting screen) is received via the operator 47 (step S73, YES), the printer driver 41a displays on the display 9 a screen for inquiring of the user about whether to execute the print job (step S75). When an operation to execute the print job is received via the operator 47 (step S75, YES), the printer driver 41a transmits print job data to the image forming apparatus 1 via the communicator 49 and the network 33 (step S77). When the operation to end the setting on the print setting screen (for example, an operation with respect to the end button provided on the print setting screen) is not received via the operator 47 (step S73, NO), the printer driver 41a returns to step S63.

As described above, according to the third embodiment, even when the user selects the automatic paper selection function after setting the stapleless stapling to ON in the print setting, or even when the user selects the stapleless stapling after setting the automatic paper selection function to ON, it is possible to allow the user to correctly perform the print setting by performing the message display, the restriction, or the like suitable for each of such cases, and to transmit the print job data in which the print setting is correctly performed, to the image forming apparatus 1.

### 3.1 Variation of Third Embodiment

In the present variation, the message displayed in step S69 is provided with a button for instructing to end the display of the message and a button for instructing to change the setting, and a step of determining which button has been selected on the message (additional step 1) is added immediately below step S69. In additional step 1, when it is determined that the button for instructing to end the display of the message has been selected, the printer driver 41a proceeds to processing of step S71. On the other hand, in additional step 1, when it is determined that the button for instructing to change the setting has been selected, and a function setting screen for changing the setting related to the function set to ON in step S65 is displayed (additional step 2), a step of determining whether the function set to ON in step S65 has been changed to OFF (additional step 3) is added in the function setting screen. When it is determined in additional step 3 that the function set to ON in step S65 has been changed to OFF, the printer driver 41a proceeds to processing of step S73. On the other hand, when it is determined in additional step 3 that the function set to ON in step S65 has not been changed to OFF, a step of determining whether the display of the function setting screen has ended (additional step 4) is added. When it is determined in additional step 4 that the display of the function setting screen has ended, the printer driver 41a returns the process to step S69, and when it is determined that the display of the function setting screen has not ended, the printer driver 41a returns the process to additional step 2 and continues to display the function setting screen.

### 4. Variations

The present disclosure is not limited to the embodiments and variations described above, and various variations are possible. In other words, the technical scope of the present disclosure also includes embodiments obtained by combining technical means that are appropriately modified within the scope of the gist of the present disclosure.

In the above-described embodiment, the stapleless stapling function has been described as the specific function, but the specific function is not limited to the stapleless stapling function. For example, the saddle stitch function may be the specific function.

In the first embodiment, a case in which the user stores the availability of the stapleless stapling for each tray number as the paper feed tray information in the storage 5, as illustrated in FIG. 4, has been described. However, instead, a size of the paper, a type of paper, or a combination of these may be linked to the availability of the saddle stitch and stored in the storage 5.

In the third embodiment, a case in which the image forming apparatus 1 and the information processing apparatus 40 are connected via the network 33 has been described, but the image forming apparatus 1 and the information processing apparatus 40 may be connected without the network 33. In this case, the image forming apparatus 1 and the information processing apparatus 40 are connected to each other by the connector 19 of the image forming apparatus 1 and the connector 51 of the information processing apparatus 40 being connected to each other.

When the specific function is a stapleless stapling function, the restriction functions may include a saddle stitch function, a poster printing function, and a photo printing function in addition to the automatic paper selection function.

In the embodiment, a program operating on each device is a program that controls a CPU or the like (a program for causing a computer to function) to realize the functions of the above-described embodiment. Information handled by such a device is temporarily stored in a temporary storage device (for example, a RAM) during processing and then stored in various storage devices such as read only memories (ROMs) and HDDs, and is read, modified, and written by the CPU as necessary.

Here, a recording medium on which the program is stored may be any of a semiconductor medium (for example, a ROM or a non-volatile memory card), an optical recording medium/a magnetic optical recording medium (for example, a digital versatile disc (DVD), magneto optical disc (MO), mini disc (MD), compact disc (CD), Blu-ray (trade name) disc (BD), or the like), a magnetic recording medium (for example, a magnetic tape or a flexible disk), and the like. Further, not only are the functions of the above-described embodiments realized by executing the loaded program, but the functions of the present disclosure may also be realized by processing in cooperation with an operating system or another application program or the like, based on instructions from the program.

Further, when a program is distributed in the market, the program can be stored in a portable recording medium and distributed, or can be transferred to a server computer connected via a network such as the Internet. In this case, it is obvious that a storage device of the server computer is also included in the present disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus comprising:
a plurality of trays in which paper attributes of paper to be accommodated are each determined; one or more controllers; and one or more storages,
wherein the one or more controllers are capable of executing a paper selection function of selecting any one of the plurality of trays and a specific function executed using any one of the plurality of trays, based on the paper attributes and job information,
the one or more storages store the tray used in a job including the specific function as the job information, and
the one or more controllers release execution of the paper selection function and set the tray stored in the one or more storages as a tray to be used when the specific function is executed when execution of the specific function is required in a state in which execution of the paper selection function is set.

2. The image forming apparatus according to claim 1,
wherein the one or more controllers are further capable of executing a restriction function having a constraint in combination with the specific function, and when a combination of the specific function and the restriction function is requested, the one or more controllers restrict execution of the specific function.

3. The image forming apparatus according to claim 1, further comprising:
a display,
wherein the one or more controllers display the tray to be used when the specific function is executed on the display.

4. The image forming apparatus according to claim 3, wherein the one or more controllers display on the display paper that can be used when the specific function is executed or a tray accommodating the paper.

5. The image forming apparatus according to claim 1, wherein the specific function is a stapleless stapling function.

6. A non-transitory computer-readable recording medium having a driver program recorded thereon, the driver program causing a computer to execute the steps of:
displaying an input screen for receiving input of a print setting related to a print job;
receiving a print setting related to either a paper selection function of selecting one of a plurality of trays included in an image forming apparatus or a specific function executed using one of the plurality of trays, based on paper attributes of paper to be accommodated in the plurality of trays, which is set in association with each of the plurality of trays, and job information via the input screen; and
not receiving the input when a request to set execution of the paper selection function is input in a state in which execution of the specific function is set.

7. A control method for an image forming apparatus including a plurality of trays having each defined paper attributes of paper to be accommodated, and capable of executing a paper selection function of selecting one of the plurality of trays and a specific function executed using one of the plurality of trays, based on the paper attributes and job information, the control method comprising:
storing the tray used in a job including the specific function as the job information; and
releasing execution of the paper selection function and setting the tray stored in the one or more storages as a tray to be used when the specific function is executed when execution of the specific function is required in a state in which execution of the paper selection function is set.
